(19) United States
(12) Patent Application Publication
(10) Pub. No.: US 2002/0070042 A1
(43) Pub. Date: Jun. 13, 2002

(54) Conduit and cable construction

(75) Inventors: Gregory D. Hansen, Peninsula, OH (US); Bradley S. Hansen, Akron, OH (US)

Correspondence Address: FAY, SHARPE, FAGAN, MINNICH & McKEE, LLP, Suite 700, 1100 Superior Avenue, Cleveland, OH, 44114-2518, US

(73) Assignee: Hudson Extrusions, Inc.

(21) Appl. No.: 09/733,353

(22) Filed: Dec. 8, 2000

Related U.S. Application Data
(60) Provisional application No. 60/170,103, filed on Dec. 10, 1999.

(51) Int. Cl. H02G 3/04

(52) U.S. Cl. 174/48

(57) ABSTRACT

An elongated extruded plastic conduit is provided. The conduit includes a first portion defining a first bore extending through and between first and second opposite ends thereof. The bore extends along a first axis, and the first portion has an outer surface. A second portion extends coextensively and is defined as a one-piece construction with the first portion. The second portion projects outwardly from the outer surface of the first portion and defines a space between itself and the outer surface of the first portion. The space is adapted to receive and retain an associated elongated cable member. The second portion includes a proximal end connected to the outer surface of the first portion and a distal end spaced from the proximal end. The distal end is connected to the outer surface of the first portion by a frangible zone of material. A conduit and cable construction is also provided and includes an extruded plastic conduit that defines a bore therethrough and an outer surface. At least one electrical cable is positioned adjacent and extends along the outer surface of the conduit. A extruded plastic sheath encompasses both the extruded plastic conduit and the cable or cables.

### CROSS-REFERENCE TO RELATED APPLICATION

This application claims priority from and hereby expressly incorporates by reference U.S. provisional application No. 60/170,103 filed Dec. 10, 1999.

### BACKGROUND OF THE INVENTION

The present invention relates to a conduit and cable construction and method of making same. In particular, the present invention relates to a conduit that includes or is adapted to receive parallel wires, cables, hoses, control lines, and/or the like as required for underground well and other applications where it has been found necessary or desirable to convey fluids in parallel with electrical power, electrical control signals, fluid power or control signals, and the like. For ease of understanding the present invention, it will be described with reference to a plastic conduit and electrical cable construction. However, it is intended that the invention be construed so as to encompass plastic conduits that include or receive other parallel lines, such as the above-mentioned hoses, control lines, and the like.

### SUMMARY OF THE INVENTION

In accordance with the present invention, an elongated extruded plastic conduit is provided. The conduit includes a first portion defining a first bore extending through and between first and second opposite ends thereof. The bore extends along a first axis, and the first portion has an outer surface. A second portion extends coextensively and is defined as a one-piece construction with the first portion. The second portion projects outwardly from the outer surface of the first portion and defines a space between itself and the outer surface of the first portion. The space is adapted to receive and retain an associated elongated cable member.

In accordance with a more limited aspect of the present invention, the second portion comprises a proximal end connected to the outer surface of the first portion and a distal end spaced from the proximal end. The distal end is connected to the outer surface of the first portion by a frangible zone of material.

In accordance with another aspect of the invention, a conduit and cable construction includes an extruded plastic conduit defining a bore therethrough and an outer surface. At least one electrical cable is positioned adjacent the outer surface and coextends with the extruded plastic conduit. An extruded plastic member projects outwardly from the outer surface of the extruded plastic conduit and holds the one or more electrical cables between itself and the plastic conduit. Preferably, the extruded plastic conduit and the extruded plastic member are defined as a one-piece construction.

### BRIEF DESCRIPTION OF THE DRAWINGS

The invention takes form from various components and arrangements of components, and in various steps and arrangements of steps, preferred embodiments of which are illustrated in the accompanying drawings that form a part hereof and wherein:

FIG. 1 is a side elevational view of a prior art conduit and cable construction;

FIG. 2A is a cross-sectional view of an intermediate conduit/cable arrangement that is used to form a conduit and cable construction in accordance with the present invention;

FIGS. 2B and 2C are cross-sectional views of first and second conduit and cable constructions formed in accordance with the present invention, respectively;

FIG. 3A is a cross-sectional view of a conduit with cable-receiving region formed in accordance with the present invention;

FIG. 3B is a cross-sectional view of the conduit of FIG. 3A and showing cables or other elongated members placed in the cable-receiving region;

FIG. 4A is a cross-sectional view of a conduit with cable-receiving region formed in accordance with another embodiment of the present invention; and,

FIG. 4B illustrates the conduit with cable-receiving region of FIG. 4A including cables or like members located in the cable-receiving region.

### DETAILED DESCRIPTION OF PREFERRED EMBODIMENTS

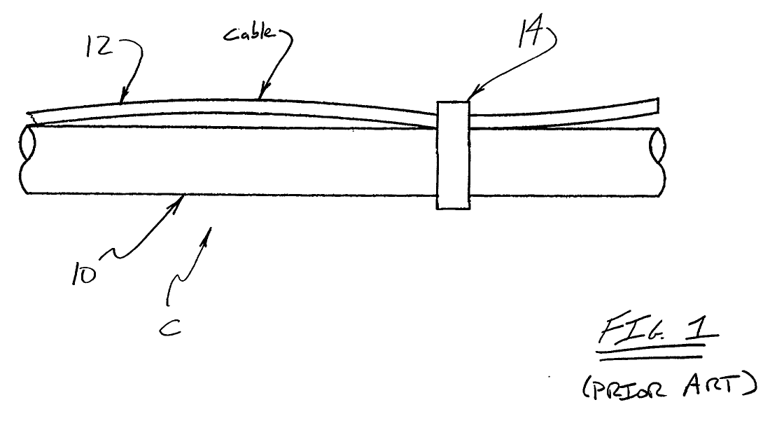

FIG. 1 illustrates a conventional conduit and cable construction C as is widely employed, e.g., in the underground water well or oil and gas well industries. A conventional elongated plastic conduit 10 is used to convey fluids from an underground well, and one or more parallel electrical cables 12 are fixedly secured to an exterior surface of the conduit using plastic cable ties, tape, or the like 14. The one or more cables 12 are used for purposes of delivering electrical power or control signals to a pump or other apparatus in the well. Typically, the cables 12 are secured to the exterior surface of the conduit 10 in the field.

The prior art conduit and cable construction C illustrated in FIG. 1 has been found to be deficient for a wide variety of reasons. Because it is typically constructed in the field, it is time-consuming to secure the cables 12 to the conduit 10 in the field using the tape or ties 14. Also, the cables 12 are not protected from the surrounding environment.

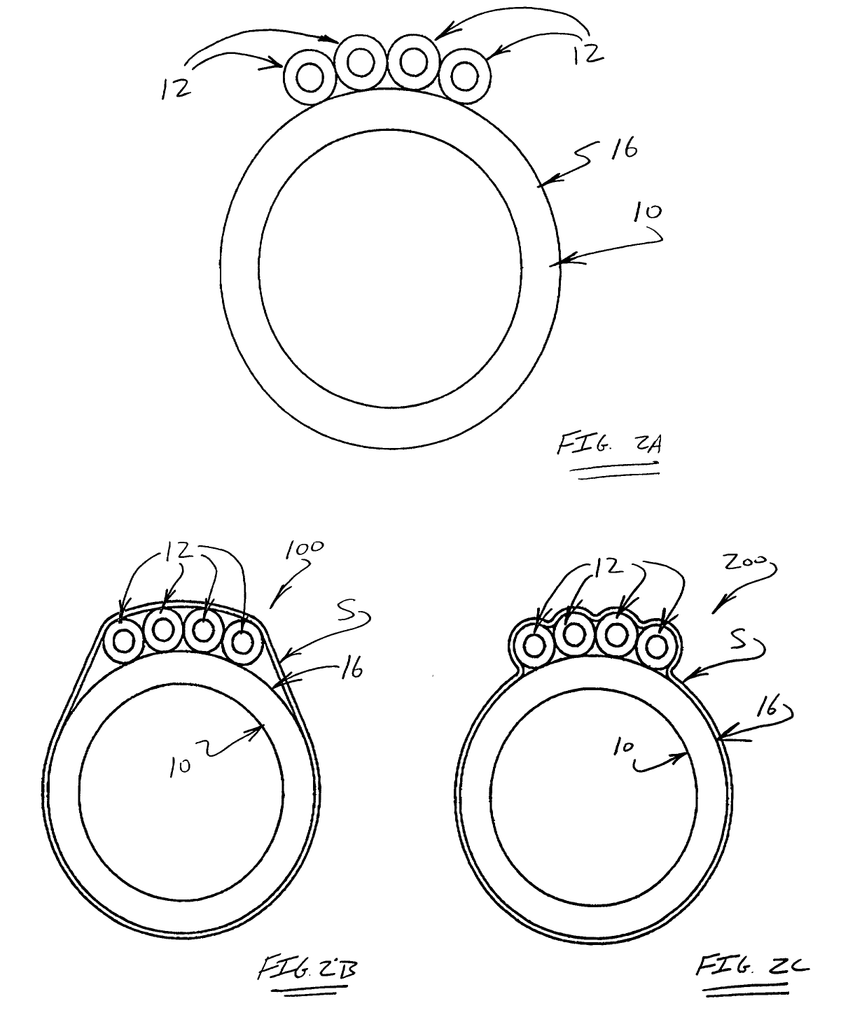

In light of the foregoing deficiencies and others associated with the construction C, a novel and non-obvious conduit and cable construction and method of manufacturing same have been developed. Referring now to FIGS. 2A-2C, an elongated plastic conduit 10 is extruded with any desired profile from a conventional material. One or more cables, wires, control hoses or lines, or the like 12 are placed in contact with an outer surface 16 of the conduit 10. Thereafter, the conduit 10, with the cables or other members 12 in place, is passed through a conventional cross-head extrusion apparatus so that an external sheath S is extruded over both the conduit 10 and the associated cables or members 12, thus forming a first embodiment of a conduit and cable construction 100 in accordance with the present invention. The sheath may be polyvinyl-chloride or any other suitable plastic material. A second embodiment of a conduit and cable construction formed in accordance with the present invention is illustrated in FIG. 2C at 200. The construction 200 is identical to the construction 100 in all respects, except that the sheath S is extruded tightly over the cables or other members 12 so that a user is able to detect and count the members 12 beneath the sheath S.

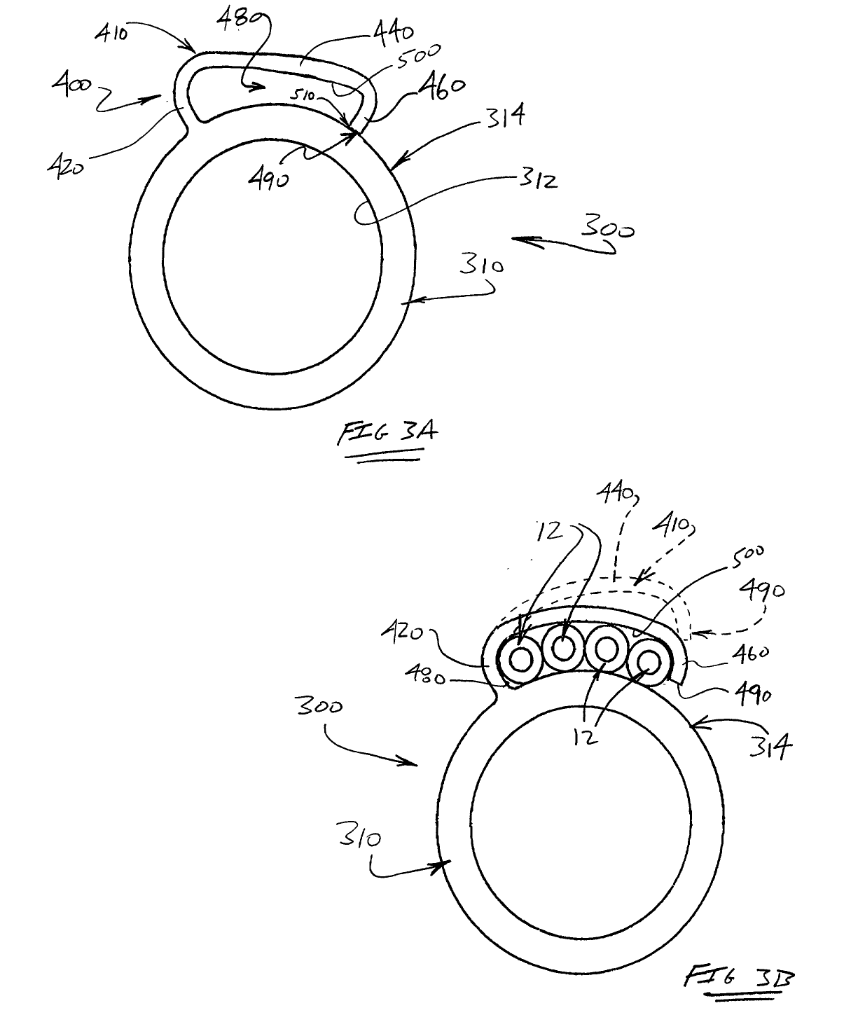

FIG. 3A illustrates an elongated conduit 300 formed in accordance with a third embodiment of the present invention and adapted for receiving and retaining cables, control hoses, control lines, or other associated members 12 in accordance with the present invention. The subject conduit 300 is preferably extruded as a one-piece construction from conventional plastic material such as high density polyethylene, low density polyethylene, medium density polyethylene, linear low density polyethylene, flexible PVC, Nylon-11, Nylon-6, or any other suitable material. The elongated conduit 300 includes a fluid-transport portion 310 that is preferably a cylindrical conformation that defines an axially extending bore 312 adapted for fluid transport and an outer cylindrical surface 314.

The conduit 300 further defines a cable-receiving region 400 adapted for releasably receiving and retaining cables, hoses, or the like that run in parallel or otherwise along the length of the fluid-transport portion 310 of the conduit 300. The cable-receiving region 400 is preferably continuous and axially coextensive with the fluid-transport portion 310. The cable-receiving region 400 is defined by a cable-retaining finger 410 that projects outwardly from the outer surface 314 and is formed as a one-piece construction with the fluid-transport conduit portion 310. In particular, the finger 410 is defined by a first portion or leg 420 that projects radially outwardly from the outer surface 314, a second portion or leg 440 that is connected to an outer end of the first leg 420 and that extends generally circumferentially above the surface 314 in a manner spaced radially therefrom, and a third portion 460 that is connected to an end of the second leg 440 and that projects radially inwardly toward the surface 314. Thus, the finger 410 defines an axially extending cable-receiving recess 480 that is adapted for receiving and retaining cables and other members such as the cables 12.

Owing to the properties of the material from which the conduit 300 is extruded, the finger 410 is resiliently biased into a closed position as shown in FIG. 3A, with a distal end 490 of the finger 410 adjacent the conduit outer surface 314. However, as illustrated in broken lines in FIG. 3B, the finger 410 is selectively movable to an open position wherein cables 12 or other elongated members are able to be placed in the cable-receiving recess 480 by passing between the conduit outer surface 314 and the distal end 490 of the resilient finger 410. As noted, the finger 410 is resiliently biased into the closed position (FIG. 3A). Accordingly, after cables 12 or the like have been placed in the recess 480 and the finger 410 is released, the distal end 490 moves radially inwardly toward the conduit outer surface 314 until an inner surface 500 of the finger 410 contacts the cables 12 or until the distal end 490 of the finger 410 again contacts the outer surface 314 of the fluid-transport conduit portion 310, whichever occurs first as depends upon the size of the cable-receiving recess 480, which may vary, and also upon the number and size of cables or other members 12 placed in the receiving recess 480. As is apparent in FIG. 3B, the inwardly directed third leg 460 prevents the cables 12 or other members from escaping when the finger moves into its closed position. The cables 12 need not be arranged as shown herein, and may be placed in any other arrangement, e.g., stacked in multiple rows or otherwise. If desired, once the members 12 are installed in the receiving recess 480, tape, wire-ties, or any other suitable device may be circumferentially wrapped around the conduit 300 to ensure that these members 12 do not escape from the recess 480. Of course, those of ordinary skill in the art will recognize that the finger 410 can take any of a wide variety of other forms without departing from the overall scope and intent of the present invention.

Preferably, during manufacture of the conduit 300, the distal end 490 of the finger 410 is connected to the outer surface 314 of the fluid-transport portion 310 by a frangible zone or web 510. This can be defined by a perforated thin-walled region of the material from which the conduit 300 is extruded, an adhesive, or any other suitable frangible material. This weakened zone 510 ensures that the finger 410 remains in its closed position as shown in FIG. 3A when the conduit 300 is coiled for storage and shipping and prevents deformation and other damage to the finger 410 that would otherwise result. Of course, this zone 510 is irreparably ruptured when the finger is moved into the open position for placement of cables 12 or the like in the receiving recess 480.

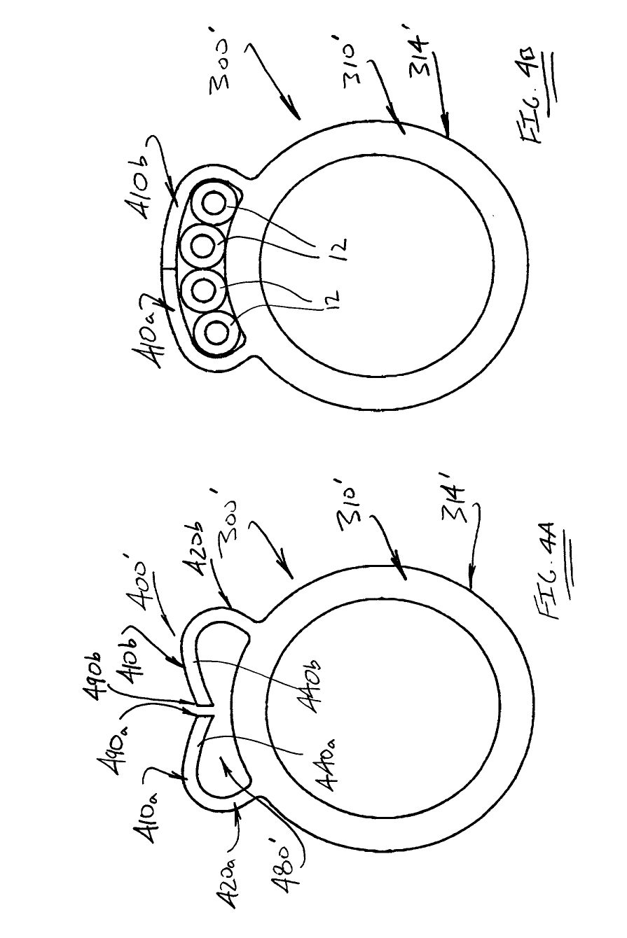

FIGS. 4A and 4B illustrate an alternative embodiment of the conduit shown in FIGS. 3A and 3B. Except as shown and described, the conduit 300′ of FIGS. 4A and 4B is identical to the conduit 300. Thus, like reference numerals including a primed (′) designation are used to identify like components relative to the conduit 300.

The cable-receiving region 400′ of the conduit 300′ is defined by first and second resilient fingers 410a, 410b. The fingers 410a, 410b include respective first legs 420a, 420b that project outwardly from the surface 314′ at circumferentially spaced locations. The fingers 410a, 410b include respective second legs 440a, 440b that project from the first legs 420a, 420b toward each other so that respective distal ends 490a, 490b of the fingers are located adjacent and/or abut each other. Here, again, these distal ends 490a, 490b can be temporarily joined by a frangible or weakened zone of plastic material or an adhesive to hold the fingers 410a, 410b together during shipping and handling.

As explained above, the fingers 410a, 410b are resilient and the ends 490a, 490b can be moved away from each other to allow placement of cables 12 or the like in the space 480′. When the fingers 410a, 410b are released, their natural resiliency moves them to the closed position as shown in FIG. 4B to hold the cables 12 in the space 480′.

The invention has been described with reference to preferred embodiments. Of course, modifications and alterations will occur to others upon a reading and understanding of the preceding specification. It is intended that the invention be construed as including all such modifications and alterations.

Having thus described the preferred embodiments, what is claimed is:

1. An elongated extruded plastic conduit comprising:
a first portion defining a first bore extending through and between first and second opposite ends of said first portion along a first axis and having an outer surface; and,
a second portion extending coextensively with and defined as a one-piece construction with said first portion, said second portion projecting outwardly from said outer surface of said first portion and defining a space between itself and said outer surface of said first portion that is adapted to receive and retain an associated elongated cable member.

2. The elongated extruded plastic conduit as defined in claim 1, wherein said space defined between said second portion and said outer surface of said first portion extends along a second axis, and wherein said first and second axes are parallel.

3. The elongated extruded plastic conduit as defined in claim 2, wherein said second portion comprises a proximal end connected to said outer surface of said first portion and a distal end spaced from said proximal end, said distal end connected to said outer surface of said first portion by a frangible zone of material.

4. The elongated extruded plastic conduit as defined in claim 3, wherein said frangible zone of material is defined as a one-piece construction with said first and second portions.

5. The elongated extruded plastic conduit as defined in claim 4, wherein said frangible zone of material defines perforations therethrough.

6. The elongated extruded plastic conduit as defined in claim 2, wherein said first portion is tubular so that said outer surface thereof is cylindrical.

7. The elongated extruded plastic conduit as defined in claim 6, wherein said second portion comprises:
a first leg connected to said outer surface of said first portion and projecting radially outwardly therefrom;
a second leg connected to said first leg at a point spaced from said outer surface and extending transverse to said first leg at a point spaced from said outer surface; and,
a third leg connected to said second leg at a point spaced from said first leg and projecting toward said outer surface.

8. The elongated extruded plastic member as defined in claim 7, wherein said second portion is resiliently biased into a closed position relative to said first portion, said closed position defined by a distal end of said third leg located adjacent said outer surface of said first portion, and wherein said second and third legs of said second portion are selectively resiliently movable away from said first portion.

9. The elongated extruded plastic member as defined in claim 8, wherein said distal end of said third leg is releasably secured to said outer surface of said first portion.

10. The elongated extruded plastic member as defined in claim 9, wherein said distal end of said third leg is secured to said outer surface by a web of plastic material formed as a one-piece construction with said first and second portions of said elongated extruded plastic member.

11. The elongated extruded plastic member as defined in claim 10, wherein said second portion is resiliently biased into a closed position wherein access to said space defined between said second portion and said outer surface of said first portion is inhibited.

12. The elongated extruded plastic member as defined in claim 11, wherein said second portion is selectively openable by movement of at least a portion of said second portion away from said outer surface whereby access to said space is allowed.

13. The elongated extruded plastic member as defined in claim 1, wherein said second portion is defined by two members that are connected to said outer surface of said first portion and that project toward each other, wherein said space is defined between said outer surface and said two members.

14. A conduit and cable construction comprising:
an extruded plastic conduit defining a bore therethrough and an outer surface;
at least one electrical cable positioned adjacent and extending along said outer surface of said extruded plastic conduit;
an extruded plastic sheath encompassing both said extruded plastic conduit and said at least one cable.

15. A conduit and cable construction comprising:
an extruded plastic conduit defining a bore therethrough and an outer surface;
at least one electrical cable positioned adjacent said outer surface and extending along said extruded plastic conduit;
an extruded plastic member projecting outwardly from said outer surface of said extruded plastic conduit and holding said at least one electrical cable between itself and said plastic conduit adjacent said outer surface.

16. The conduit and cable construction as defined in claim 15, wherein said extruded plastic conduit and said extruded plastic member are defined as a one-piece construction.

17. The conduit and cable construction as defined in claim 16, comprising:
first and second plastic members projecting outwardly from said outer surface and together holding said at least one electric cable adjacent said outer surface.

18. The conduit and cable construction as set forth in claim 15, wherein said at least one electrical cable comprises a plurality of electrical cables arranged parallel to each other.
